(19) United States
(12) Patent Application Publication
(10) Pub. No.: US 2014/0043044 A1
(43) Pub. Date: Feb. 13, 2014

(54) FUEL SENSOR BASED ON MEASURING DIELECTRIC RELAXATION

(71) Applicants: Alan Parker, Abingdon (GB); Andrew Jessop, Oxford (GB)

(72) Inventors: Alan Parker, Abingdon (GB); Andrew Jessop, Oxford (GB)

(21) Appl. No.: 13/984,610

(22) PCT Filed: Feb. 10, 2012
(86) PCT No.: PCT/EP12/52331

§ 371 Date: Oct. 21, 2013

(30) Foreign Application Priority Data
Feb. 10, 2011 (GB) 1102401.5

(51) Int. Cl. G01N 27/02

(52) U.S. Cl. CPC G01N 27/02
USPC 324/633

(57) ABSTRACT

Fuel sensor (100) and method for detecting physical properties of a fuel comprising a probe (10) and a circuit (110) having an oscillator arranged to apply multiple frequencies to the probe (10) and measure electrical properties of fuel proximal to the probe (10) in response to the applied multiple frequencies, wherein the circuit (110) has one or more outputs (160) arranged to indicate physical properties of the fuel, and wherein the one or more outputs (160) vary in response to the measured electrical properties. More particularly, fuel composition and level in terms of fuel, water and ice is determined by measuring dielectric relaxation.

### FIELD OF THE INVENTION

The present invention relates to a fluid sensor and in particular a fluid sensor used to measure properties of fuel.

### BACKGROUND OF THE INVENTION

Ice formation in aircraft fuel systems can result from the presence of dissolved and undissolved water in the fuel. Dissolved water or water in solution with hydrocarbon fuels constitutes a relatively small part of the total water potential in a particular system with the quantity dissolved being primarily dependent on the fuel temperature and the water solubility characteristics of the fuel.

Water may be entrained as water particles suspended in the fuel as a result of mechanical agitation of free water or conversion of dissolved water through temperature reduction. Free water may be introduced as a result of refuelling or the settling of entrained water which collects at the bottom of a fuel tank in easily detectable quantities separated by a continuous interface from the fuel above. Water may also be introduced as a result of condensation from air entering a fuel tank through a vent system. Entrained water may settle out in time under static conditions and may or may not be drained, depending on the rate at which it is converted to free water. In general, it is not likely that all entrained water can ever be separated from fuel under field conditions. The settling rate depends on factors including temperature, quiescence and droplet size. The droplet size may vary depending upon the mechanics of formation.

Usually the particles are so small as to be invisible to the naked eye, but in extreme cases may cause a slight haziness in the fuel. Free water can be drained from a fuel tank if low point drain provisions are adequate. Water in solution cannot be removed easily except by dehydration or by converting it, through temperature reduction, to entrained, then to free water. Water in solution may not a serious problem in aviation fuel so long as it remains in solution. Entrained and free water are the most dangerous because of the potential of freezing on the surfaces of the fuel system. Further, entrained water will freeze in cold fuel and tend to stay in solution longer since the specific gravity of ice is approximately the same as that of hydrocarbon fuels.

Free water can also cause capacitive fuel level sensors to output incorrect fuel level readings. Small amounts of water in contact with the probe can cause erroneous readings. Larger amounts of water can cause the electronics to stop working.

Capacitance probes encounter a problem when the water level in a fuel tank reaches the bottom of the probe. In this situation, the conductivity of water acts as a short circuit and sensor measurement becomes less accurate. In large commercial aircraft, fuel level sensors typically use capacitance probes or ultra sonic sensors.

WO2010/139974 describes an aircraft fuel level sensor based on an arrangement of annular capacitors. As well as the previously mentioned disadvantages of capacitive sensors, this probe increases complexity in a fuel level monitoring system by requiring a multiplexor to measure the capacitance of each annular capacitor in turn.

Therefore, there is a requirement for a liquid sensor that overcomes these problems and is capable of detecting and discriminating between at least air, fuel, water in both liquid and solid (ice) phases and is preferably able to measure the level of water in a fuel tank.

### SUMMARY OF THE INVENTION

Against this background and in accordance with a first aspect there is provided a fluid sensor for detecting physical properties of a fluid comprising:

a probe; and

a circuit having an oscillator arranged to apply multiple frequencies to the probe and measure electrical properties of fluid proximal to the probe in response to the applied multiple frequencies, wherein the circuit has one or more outputs arranged to indicate physical properties of the fluid, and wherein the one or more outputs vary in response to the measured electrical properties. Different potential components of fuel exhibit different electrical properties as an electrical field is applied. Therefore, a single probe with associated electrical connections can provide more accurate information regarding fuel composition and amount remaining.

The fluid sensor may be used to detect water and/or ice in fuel in different proportions and consistency as well as detecting the presence of, properties & amount of fuel slush (this can be formed when either water in the fuel or parts of the fuel itself begin to freeze and can for example consist of hydrocarbon crystals or hydrocarbon suspensions in water or ice and water mixtures).

Preferably, the electrical properties may be one or more selected from the group consisting of: capacitance, conductance, real and imaginative permittivity, dielectric relaxation and phase. Physical properties of the fluid may be measured by detecting or observing how one or more of the electrical properties varies with applied frequency. In particular, such physical properties may be determined from how one (or more) electrical property changes with respect to another (or more) at or across one or more frequencies.

Advantageously, the physical properties of the fluid may include any or more of: purity, contaminant content, fluid level, composition, and contaminant type.

Optionally, the contaminant type may include water, ice and/or slush. This is especially important for aviation fuel.

Optionally, the circuit may be arranged to apply multiple frequencies by smoothly varying the frequency across a frequency range. Discreet steps may also be used. Measurements may be taken continuously or at intervals as the frequency changes.

Preferably, the multiple frequencies may be across a range of 100 Hz to 1 MHz.

Optionally, the circuit may be coupled to the probe by a coaxial cable. Other cable types may be used.

Preferably, the probe may be a metal probe.

Optionally, the probe may comprise a plurality of separated metal plates. The spacing of the plates may be chosen to match the expected electrical properties of the fluid.

Optionally, there may be two or three metal plates. The plate configuration may be chosen to match the expected measurement properties.

Optionally, the fluid sensor may further comprise a plurality of probes and wherein the circuit is further arranged to apply multiple frequencies to each of the plurality of probes and measure electrical properties of fluid proximal to each of the plurality of probes in response to the applied multiple frequencies. Therefore, fluid may be sensed and different positions.

Preferably, the plurality of probes may be arranged at different levels within a fluid containing in order to measure properties of fluid at the different levels within the container. This may be particularly useful for use in a fuel level monitoring system.

Advantageously, the fluid may be predominantly a hydrocarbon.

According to a second aspect there is provided a method for detecting physical properties of a fluid, the method comprising the steps of:

providing a probe;

applying multiple frequencies to the probe; and

measuring electrical properties of fluid proximal to the probe in response to the applied multiple frequencies, wherein the measured electrical properties includes at least a measurement of dielectric relaxation.

Instead of dielectric relaxation, other electrical properties may be measured, such as capacitance, conductance, real and imaginative permittivity and phase, for example.

Preferably, the physical properties of the fluid may include any or more of: purity, contaminant content, fluid level, composition, and contaminant type.

Advantageously, the contaminant type may include water, ice and/or slush (for example, hydrocarbon crystals or hydrocarbon suspensions in water or ice and water mixtures).

Preferably, the fluid may be predominantly a hydrocarbon such as fuel.

The method may be used to detect a fluid. This method may be used to detect water (i.e. proportions or amounts) and/or ice in fuel in different proportions and consistency as well as detecting the presence of, properties & amount of fuel slush (this can be formed when either water in the fuel or parts of the fuel itself begin to freeze and can for example consist of hydrocarbon crystals or hydrocarbon suspensions in water or ice and water mixtures). The term fluid may include slush or other mixtures.

Preferably, the hydrocarbon may be aviation or other fuel (e.g. car, ship, boat, train or power station fuel).

In accordance with a third aspect there is provided a fuel level indicator for indicating the level of fuel, water, ice and/or slush within a fuel tank comprising any fluid sensor described above.

In accordance with a fourth aspect there is provided an aircraft comprising any fluid detector or fuel level indicator described above.

It should be noted that any feature described above may be used with any particular aspect or embodiment of the invention.

### BRIEF DESCRIPTION OF THE FIGURES

The present invention may be put into practice in a number of ways and embodiments will now be described by way of example only and with reference to the accompanying drawings, in which:

FIG. 1 shows a schematic diagram of a liquid probe, given by way of example only;

FIG. 2 shows a schematic diagram of a fluid sensor including the liquid probe of FIG. 1 and given by way of example only; and FIG. 3 shows a graph of ice permittivity over a range of temperatures.

It should be noted that the figures are illustrated for simplicity and are not necessarily drawn to scale.

### DETAILED DESCRIPTION OF THE PREFERRED EMBODIMENTS

The following describes an aircraft fuel tank detection system used to measure the amount or composition of aviation fuel, water, ice, slush and/or air in the tank. However, the apparatus may be used with other fluids, fuels or compositions and receptacles (e.g. pipelines) in different applications.

Fuel, water, ice, slush and air have particular electrical properties when different electrical frequencies are applied. Typically, frequencies of less than 1MHz may be applied and these are considered to be low frequency signals in this context. For example, air has a very low capacitance and a very low conductance. Aviation fuel has a very low conductance but a higher capacitance than air (εᵣ≈2). Therefore, fuel and air can be distinguished at a single electrical frequency.

Water has a high capacitance (Eᵣ80) and its conductance decays as the applied frequency increases. Furthermore, this conductance is a function of the ionic content of the water.

Ice has a similar capacitance to fuel, but has a dielectric relaxation in a low kHz range. This may be measured either in the capacitance or the phase of a detected signal, and has well defined temperature dependence (see FIG. 3).

Therefore, by measuring the capacitance, conductance and phase over a range of frequencies from approximately 100 Hz to 1 MHz, the proportion of fuel, water, ice, slush and/or air within, around or proximate to a probe may be determined.

Equations 1 and 2 provide an approximation of the dielectric relaxation properties of ice. These equations have been used to derive the graph shown in FIG. 3.

$$\begin{matrix}{ɛ}_{ice} ( f , T ) = {ɛ}_{ice , ∞} + \frac{{ɛ}_{ice , static} - {ɛ}_{ice , ∞}}{1 + [ \frac{j f}{{f}_{0} ( T )} ]} & equation 1 \\ {f}_{0} ( T ) = \frac{1}{2 π} {10}^{- [ \frac{664.873}{T} - 7.447 ]} & equation 2\end{matrix}$$

Where ε∞ is the real permittivity of ice (1-h) at optical frequencies, ε_{ice,static} is the real permittivity of ice at DC, f is the frequency of interest, f₀is the frequency of dielectric relaxation of ice (1-h), and T is the temperature

(Electromagnetic Aquametry, Klaus Kupfer (Ed.), Springer, 3540222227, 2005, p.370)

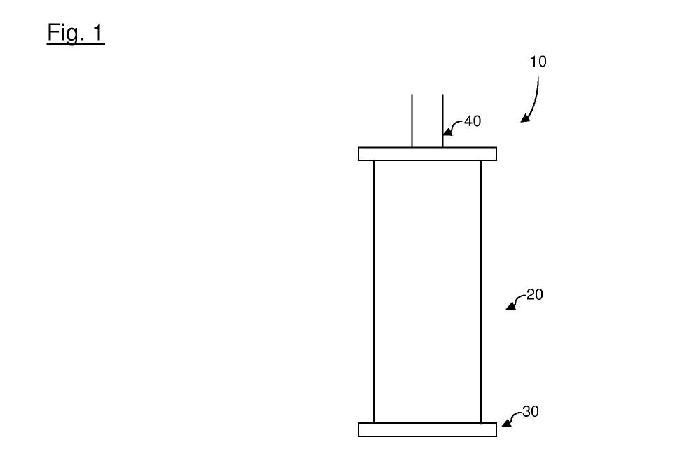

FIG. 1 shows a schematic diagram of a metal probe 10 that can be used to apply the different low frequency electrical signals to an aircraft fuel source. The probe 10 comprises a pair (two) of parallel metal plates 20 separated by end spacers 30 and connected to a cable, which may be a coaxial cable 40, for example.

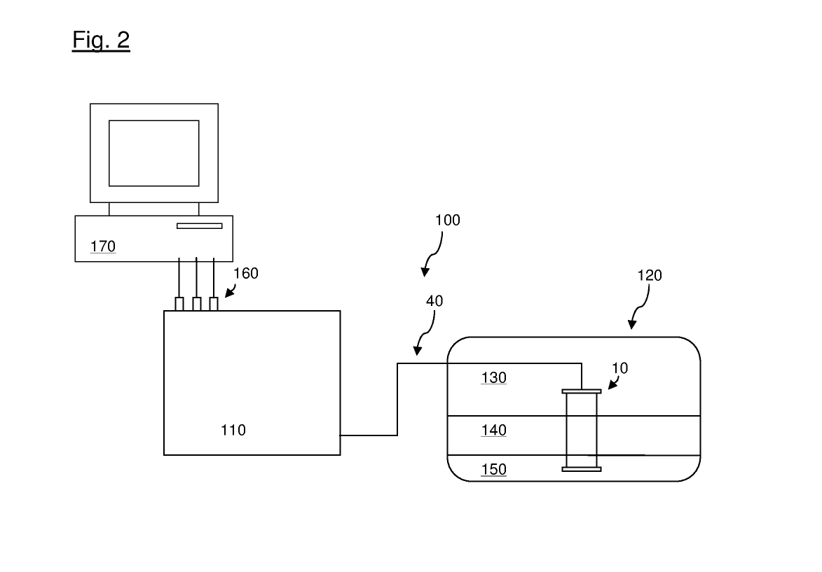

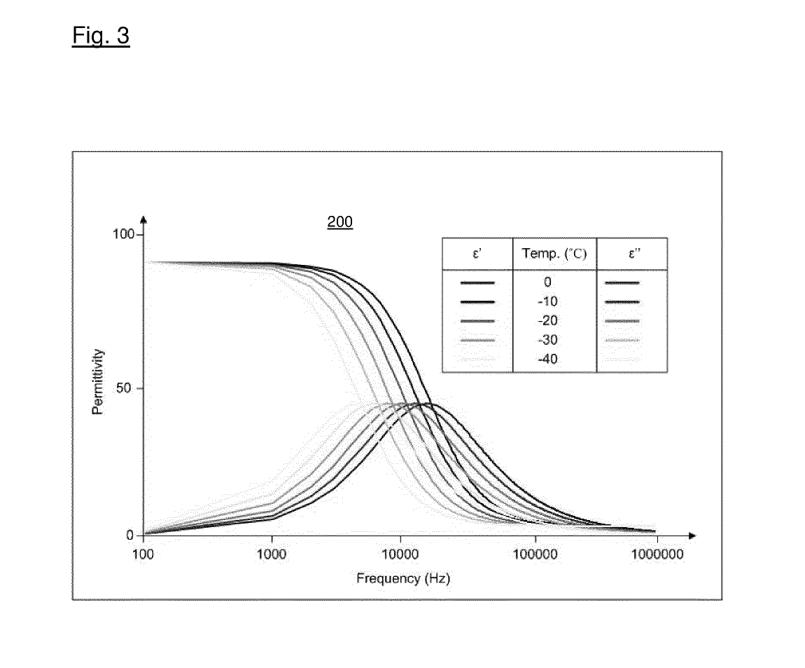

FIG. 2 shows a schematic diagram of a fluid sensor system 100 comprising electronic circuitry 110, coupled to the metal probe 10 by the coaxial cable 40. The probe 10 is located vertically within a fuel tank 120, which in this example contains stratified layers of air 130, fuel 140 and water 150. The electronic circuitry 110 has a plurality of electrical outputs 160 that vary in response to applied frequencies to the probe 10. The outputs 160 are connected to a processor or computer 170 that interprets signals coming from the outputs 160 and provides an indication of the fluid surrounding or in contact with the probe 10.

The circuitry 110 may apply multiple frequencies to the probe 10 at discreet steps, or swept smoothly over a continuous range of frequencies. The electronic circuitry 110 then measures the real and/or imaginary permittivity at the probe 10 to determine properties of the fluid or mixture of fluids within the fuel tank 120.

For example, if the probe 10 is located in water, then a real permittivity of 80 may be detected and this is substantially the same across a range of frequency from 100 Hz to 1 MHz. In a further example, at 100 Hz, a measurement of capacitance may be made in order to determine whether the probe is located in air, fuel, slush or water/ice (water and ice both have an approximate real permittivity of about 80 at this frequency). If such a permittivity is determined, then ice or water must be present. Therefore, a frequency or sweep or change may be made to apply multiple frequencies to the probe 10 with measurements made across the range. A reduction in capacitance as the frequency increases, together with a peak in conductance and phase indicates that ice is present rather than water.

Preferably, the electronic circuitry 110 operates at low power.

The probe 10 may be horizontal to detect the specific fluid at a particular level in the fuel tank 120. Alternatively, the probe 10 may be vertical, as shown in FIG. 2, in order to detect a continuous level of water, fuel, ice or air.

As will be appreciated by the skilled person, details of the above embodiment may be varied without departing from the scope of the present invention, as defined by the appended claims.

For example, the probe 10 may comprise three or more separated plates. Alternatively, the probe 10 may be a single electrode that measures electrical properties of the fluid using the fuel tank wall as the other electrode, which receives the signal of varying frequencies from the electronic circuit 110.

The cable does not need to be coaxial, but may be any other type suitable for use within the frequency range. Instead of a computer or processor, the electrical circuit 110 may provide signals to a fuel gauge system in order to provide a more accurate indication of remaining fuel and/or provide an indication of fuel quality and whether or not the fuel system is freezing up.

Permittivities for jet fuel range from approximately 2.0 to 2.2. A specific dielectric relaxation in ice occurs around 10 KHz and its concentration may be determined from a magnitude of phase or capacitance peak. Once the amount of ice is determined from these measurement (i.e. the magnitude of the peak), then the fuel content may be found from its capacitance using a look-up table based on the matrix of measurements, either calculated, estimated or previously measured as calibration data.

Multiple probes may be placed at different levels within a fuel tank, for example. This arrangement may be used to determine how fuel composition varies within a tank and also the actual amount of fuel present.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A fluid sensor for detecting physical properties of a fluid comprising:
a probe; and
a circuit having an oscillator arranged to apply multiple frequencies to the probe and measure electrical properties of fluid proximal to the probe in response to the applied multiple frequencies, wherein the circuit has one or more outputs arranged to indicate physical properties of the fluid, and wherein the one or more outputs vary in response to the measured electrical properties; and
wherein the measurement of electrical properties includes at least a measurement of dielectric relaxation.

2. The fluid sensor of claim 1, wherein the electrical properties may further be one or more selected from the group consisting of: capacitance, conductance, real and imaginative permittivity and phase.

3. The fluid sensor of claim 1 or claim 2, wherein the physical properties of the fluid include any or more of: purity, contaminant content, fluid level, composition, and contaminant type.

4. The fluid sensor of claim 3, wherein the contaminant type includes water, ice and/or slush.

5. The fluid sensor according to claim 1, wherein the circuit is arranged to apply multiple frequencies by smoothly varying the frequency across a frequency range.

6. The fluid sensor according to claim 1, wherein the multiple frequencies are across a range of 100 Hz to 1 MHz.

7. The fluid sensor according to claim 1, wherein the circuit is coupled to the probe by a coaxial cable.

8. The fluid sensor according to claim 1, wherein the probe is a metal probe.

9. The fluid sensor according to claim 1, wherein the probe comprises a plurality of separated metal plates.

10. The fluid sensor of claim 9, wherein there are two or three metal plates.

11. The fluid sensor according to claim 1, further comprising a plurality of probes and wherein the circuit is further arranged to apply multiple frequencies to each of the plurality of probes and measure electrical properties of fluid proximal to each of the plurality of probes in response to the applied multiple frequencies.

12. The fluid sensor of claim 11, wherein the plurality of probes are arranged at different levels within a fluid containing in order to measure properties of fluid at the different levels within the container.

13. The fluid sensor according to claim 1, claim, wherein the fluid is predominantly a hydrocarbon.

14. The fluid sensor of claim 13, wherein the hydrocarbon is aviation fuel.

15. A fuel level indicator for indicating the level of fuel, water and/or ice within a fuel tank comprising the fluid sensor according to claim 1.

16. An aircraft comprising the fluid detector or fuel level indicator according to claim 1.

17. A method for detecting physical properties of a fluid, the method comprising:
providing a probe;
applying multiple frequencies to the probe; and
measuring electrical properties of fluid proximal to the probe in response to the applied multiple frequencies, wherein the measured electrical properties includes at least a measurement of dielectric relaxation.

18. The method of claim 17, wherein the physical properties of the fluid include any or more of: purity, contaminant content, fluid level, composition, and contaminant type.

19. The method of claim 18, wherein the contaminant type includes water, ice and/or slush.

20. The method of claim 18 or claim 19, wherein the fluid is predominantly a hydrocarbon.
